(19) United States
(12) Patent Application Publication
(10) Pub. No.: US 2013/0218632 A1
(43) Pub. Date: Aug. 22, 2013

(54) CATEGORY-AGNOSTIC LEADSTORE

(71) Applicant: Reply! Inc., (US)

(72) Inventors: Payam Zamani, Danville, CA (US); Reza Hajebi, San Carlos, CA (US); Paul O'Leary, San Francisco, CA (US)

(73) Assignee: REPLY! INC., San Ramon, CA (US)

(21) Appl. No.: 13/773,204

(22) Filed: Feb. 21, 2013

Related U.S. Application Data
(60) Provisional application No. 61/601,526, filed on Feb. 21, 2012.

(51) Int. Cl. G06Q 30/02

(52) U.S. Cl. CPC G06Q 30/0201
USPC 705/7.29

(57) ABSTRACT

A lead store system may receive a plurality of leads in a plurality of formats. The leads may include a set of information about a prospective customer who may desire to purchase a good or service. The leads may be converted into a universal format and, on some occasions, the universal format being category and/or industry agnostic. The converted leads may be stored in a database and when a request for a lead from a lead buyer is received a criterion included in the lead request may be matched to a stored converted lead. The matching lead may them be provided to the lead buyer.

### RELATED APPLICATION

This patent application is a NONPROVISIONAL of, and claims priority to, and incorporates by reference U.S. Provisional Patent Application 61/601,526, filed 21 Feb. 2012.

### FIELD OF INVENTION

The present invention relates to a category-agnostic LeadStore that may find application in conjunction with various different types of leads.

### BACKGROUND

One of the many uses of the Internet is to connect Customers who are contemplating a transaction (“Customer Lead”) to Service Providers who want to compete for their business. A Customer Lead often consists of contact information and other information about a transaction that a customer is interested in, collected from a customer who has asked to be put in touch with a Service Provider. Customer Leads are fungible products that are sold to one or more Service Providers (“Lead Buyers”). Customer Leads are not purchase requests per se, rather they consist of the information necessary for a Service Provider to contact a customer in an effort to acquire the customer's business.

In conventional lead distribution methodologies, Customer Leads are gathered in industry-specific formats. Service Providers must either conform their leads forms to those formats or risk missing potential Customer Leads. This results in inefficiencies because Customer Leads that may be of interest for Service Providers may be missed as a result of mismatches between the lead form formats and the Customer Leads information.

### SUMMARY

A category-agnostic LeadStore and a system, computer-readable media, and method for implementing same are herein described. In some embodiments, a plurality of customer leads may be received by, for example the LeadStore. Typically, each lead will include a set of information about a prospective customer who may want to purchase a good or service. For example, a lead may include the prospective customer's name, location, and type of good or service the customer wishes to purchase. The leads may be received in a variety of formats, some of which may be, for example, industry and/or category specific. Upon receipt, the leads may be converted to a universal format that is category and industry agnostic and stored in, for example, a database.

A request for a lead may be received from a lead buyer. In some embodiments, the lead request may include one or more criterion or a set of parameters for a desired lead. For example, a lead request may include a lead type, a lead category, a prospective customer type, and/or a location. The received criterion may then be matched to a stored lead and provided to the lead buyer. A lead buyer may have a standing request to receive notification of new leads that match one or more criterion via, for example, a lead buyer registration process.

On some occasions, payment for the matching lead may be requested from the lead buyer prior to providing the matching lead to the lead buyer. On these occasions, payment may be received from the lead buyer and the matching lead may be provided to the lead buyer responsively to receiving the payment.

In one embodiment, a portion of the leads may be received from a particular lead seller. On some occasions, this portion of leads may be grouped into a lead seller campaign and characteristics of the leads included in the lead seller campaign may be tracked over time by, for example, the lead seller and/or the LeadStore system. Exemplary characteristics include the frequency of viewing a lead or leads included within the lead seller campaign, the method of lead generation, the format of lead presentation, and the purchase history of leads included in the lead seller campaign.

In another embodiment, the lead buyer may have a lead buyer campaign that includes a set of parameters for desired leads and when the LeadStore receives the lead buyer campaign, leads may be provided to the lead buyer responsively to the received lead buyer campaign. On some occasions, when the LeadStore receives a new lead, it may be determined whether the newly received lead matches the lead buyer campaign and, if so, the lead buyer may be notified of the newly received bid.

Exemplary systems disclosed herein include a link, a processor, and a storage unit communicatively coupled to one another. The link may be configured to receive a plurality of customer leads, the leads being in a variety of formats, wherein each lead includes a set of information about a prospective customer who may purchase a good or service, receiving a request for a lead from a lead buyer, the request including at least one criterion, and providing the matching lead to the lead buyer. The processor may be configured to receive the leads and requests for a lead from the link, convert the leads to a universal format, the universal format being category and industry agnostic, accessing a storage unit configured to store the converted leads upon receiving the request for the lead, matching the criterion of the received request to a stored converted lead, and providing the matching lead to the link and the storage unit may be configured to store the converted leads.

### BRIEF DESCRIPTION OF THE DRAWINGS

The present invention is illustrated by way of example, and not limitation, in the figures of the accompanying drawings in which:

FIGS. 1 and 2 illustrate examples of a computer system Web-based implementation of a LeadStore system, in accordance with embodiments of the present invention;

FIG. 3 includes a simplified illustration of a computer network 100, in accordance with embodiments of the present invention;

FIG. 4 shows a block diagram illustrating an example of a computer system, in accordance with embodiments of the present invention;

FIG. 5 shows an architecture view of computer system, in accordance with embodiments of the present invention; and

FIGS. 6-9 are screenshots depicting exemplary interfaces, in accordance with embodiments of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### WRITTEN DESCRIPTION

The present invention addresses the above-identified inefficiencies in conventional lead distribution methodologies by providing a category-agnostic LeadStore, which is configured to store Customer Leads in a universal (i.e., industry- or category-agnostic) format. From the LeadStore, the Customer Leads can then be distributed to potential Lead Buyers (e.g., on-demand, on a subscription basis, pursuant to a lead purchase campaign, etc.), responsive to criteria specified by those Lead Buyers. Because the leads are available in the universal format, they are easily matched to lead criteria specified by the potential Lead Buyers. This reduces the inefficiencies noted above and allows Service Providers greater flexibility in purchasing leads. The present systems and methods are particularly applicable to a Web-based lead collection and distribution mechanisms and it is in this context that the present invention will be described. It should be appreciated, however, that the present invention has greater utility since it may be implemented in different manners, may be based on different architectures and is not limited to the particular types of leads described below. Further, the category-agnostic LeadStore may be used in conjunction with various types of leads including leads for goods purchases or leads for services. In some instances (e.g., in large market segments such as autos, real estate, home repair, etc.), leads submitted to the LeadStore may be so submitted through industry-specific forms.

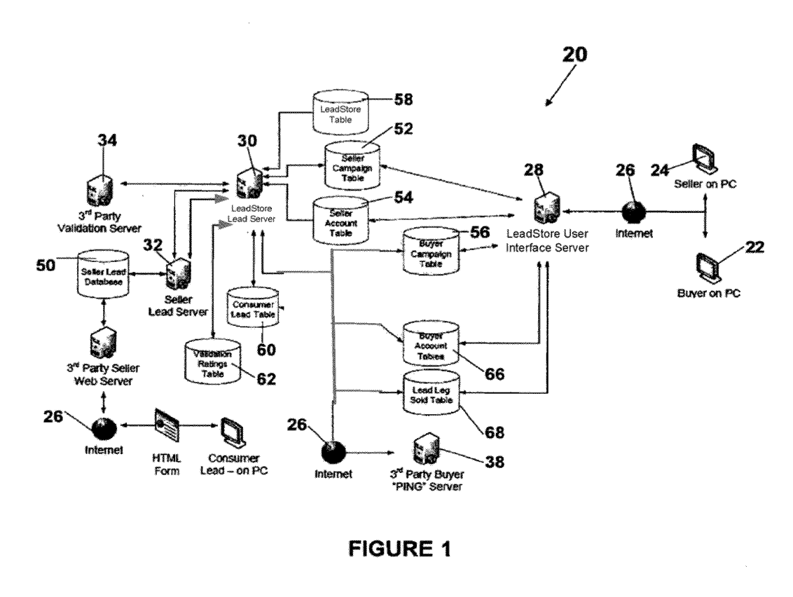

FIG. 1 illustrates an example of a computer system Web-based implementation of a LeadStore system 20. The LeadStore system brings Lead Buyers 22 and Lead Sellers 24 together for the purchase and sale of Customer Leads. The Customer Leads may include any type of leads including, but not limited to, consumer leads and business-to-business leads. The Lead Buyer and Lead Seller may be coupled to the LeadStore system over a link 26, such as the Internet or any other communications or computer network whether wired or wireless, to a LeadStore user interface unit 28, such as a server computer, that executes computer code to generate and provide the user interfaces to the Lead Buyer 22 and Lead Seller 24 who each access the LeadStore system 20 using a computing device that executes a browser application that displays Web pages.

Each computing device may be a processing unit based device with sufficient processing power, memory and connectivity to interact with the LeadStore system as described below wherein each computing device may be, for example, a personal computer, a laptop computer, a smart telephone, a terminal, a mobile phone, a wireless email device, etc.

A lead is a set of information about a customer who may purchase a product or service wherein the lead can be generated in various different manners. For example, a lead (including a Customer Lead which is contact and transaction information that might lead to the acquisition of a customer for a product or service) may be a person who is looking for a plumber in the Reno, Nev. area to perform a particular task, a person with a 520 credit rating and living in Livermore who is looking for a mortgage of $500,000, or a person in the Boston area who wants to purchase a new car and is willing to spend a defined amount. Each of these is a different type of lead and the LeadStore system can be used with any type of lead.

A Lead Buyer is an entity (individual, corporation, etc.) that is willing to pay a certain price for a quantity of a particular type of lead for a particular good or service. An example of a Lead Buyer is home repair service provider who is willing to pay for leads for homeowners looking for a repairperson in a certain geographic area or a plumber who is willing to pay for leads to people nationally who need to have their houses re-piped. Each Lead Buyer may have one or more buyer campaigns wherein each buyer campaign provides the parameters of the leads desired (such as the types of the leads, the number of leads, time period for the leads, the budget for the leads over the time period, geographic area, etc.) that are of interest to the Lead Buyer.

A Lead Seller is an entity (individual, corporation, etc.) that wants to sell a particular type of lead for a particular good or service, such as a company that runs a mortgage advice Website and collects mortgage leads. Each Lead Seller may have one or more seller campaigns wherein each seller campaign provides a means of grouping and tracking particular leads over time for the purpose of attributing leads to the appropriate Lead Seller and tracking the quality of the leads sold.

The LeadStore system 20 may further comprise a LeadStore lead unit 30, such as one or more server computers that execute computer code in one implementation that accepts and stores new leads of any type. The LeadStore lead server may communicate with a seller lead unit 32, such as one or more server computers that execute computer code in one implementation, that interfaces with and stores third party leads to be sold, a third party validation unit 34, such as one or more server computers that execute computer code in one implementation, that validates third party leads, and a third party buyer ping unit 38, such as one or more server computers that execute computer code in one implementation, that implements a ping campaign as is described below in more detail. The LeadStore system 20 may further comprise a consumer-rating unit (not shown in detail), such as one or more server computers that execute computer code in one implementation that provide a rating process.

The LeadStore system 20 may further include one or more storage units, such as database tables in one implementation of the system that store data and are accessed by the various units of the system as described above. The system 20 may thus comprise a seller lead database 50 that stores third party seller leads and interacts with the lead unit 30, a seller campaign table 52 that stores a plurality of Lead Seller campaigns for a plurality of Lead Sellers in the LeadStore system, and a seller account table 54 that stores account information about each seller in the LeadStore system. In one embodiment, the seller account table may include an Object ID field, Identification Fields, a Login field, a Password field, and Payment Information fields and the seller campaign table may include an Object ID field, a Seller ID field, a User Defined Name field, a Collection Method field and a Quality Rating field. The Lead Seller campaigns enable the Lead Sellers to track the performance of different variations of Customer Leads generated using different methods.

The LeadStore system may further comprise a buyer campaign table 56 that stores a plurality of Lead Buyer campaigns for a plurality of Lead Buyers in the LeadStore system, and the category-agnostic LeadStore 58 that stores the different types of leads (such as for mortgages, plumbers, autos, etc.) in accordance with the universal format described below.

LeadStore 58 stores leads in a universal lead format, allowing the LeadStore system to handle any lead type with no category-specific implementation work required. Thus, leads can be generated in/for any category and can be distributed (sold) in any category. Lead Buyers can either pick and choose leads for purchase or can specify automatic delivery of leads from the LeadStore according to defined criteria.

In one embodiment of the invention, the universal format may include (a) a Taxonomy Section having a variable number of tiers, (b) a geography section (which can be organized in different ways to accommodate zip codes, counties, cities, states, etc.) for specifying the location of the service to be provided and/or product to be purchased, (c) a contact section for contact details regarding the lead, and a client-specific data section for information related to the intake of the lead that can be used later, if needed. This can be important in certain instances as it may influence to whom the lead is distributed. Examples of the client-specific data section may be:
ClientDataPacket
   ClientData
      Name: company_id
      Value: 5370972
   ClientData
      Name: Merchant Phone
      Value: 555-555-5555
         This universal format may also include any number of detail sets, comprised of any number name/value detail sections, including a section name. In this way, any vertical-specific information is represented in a single format. Examples include:
Detail Set:
SetName: Vehicle Questionnaire
Details:
   Detail
      Name: Vehicle year
      Value: 1983
   Detail
      Name: Vehicle make
      Value: Ford
   Detail
      Name: Vehicle model
      Value: Ranger
         Detail sets such as the one above can be read by a universal reader, knowing nothing of vertical, to produce a result such as:
Vehicle Questionnaire
Vehicle year: 1983
Vehicle make: Ford
Vehicle model: Ranger
   In addition, sets can be nested within details themselves, and to any depth. An example for an auto insurance lead with incident history might be:
Detail Set:
SetName: Incidents in Past 5 Years
Details:
   Detail:
      Detail Set:
         SetName: Incident Information
         Details:
         Detail
         Name: Type of incident
         Value: Ticket
         Detail
         Name: Date of incident (approx.)
         Value: Feb. 4, 2009
         Detail
         Name: Reason for ticket
         Value: Speeding
   Detail:
      Detail Set:
         SetName: Incident information
         Details:
         Detail
         Name: Type of incident
         Value: DUIIDWI
         Detail
         Name: Date of incident (approx)
         Value: Jan. 14, 2010
         Detail
         Name: State
         Value: South Carolina
            The above can be read by a universal reader, knowing nothing of vertical, to produce a result such as:
Incidents in Past 5 Years
Incident Information
Type of incident: Ticket
Date of incident (approx): Feb. 4, 2009
Reason for ticket: Speeding
Incident Information
Type of incident: DUIIDWI
Date of incident (approx): Jan. 14, 2010
State: South Carolina

The LeadStore system 20 may further include a Consumer Lead table 60 that interfaces with the LeadStore lead unit 30 and stores information about each Customer Lead in the LeadStore system and a validating ratings table 62 that interfaces with the LeadStore lead unit 30 and stores information about the validating ratings of the leads. In one embodiment, the Consumer Lead table may include an Object ID field, a Ping ID field, a Seller Campaign ID field, an Auction Thread ID field, a Lead Type field, Consumer Contact Information fields, a Generated Timestamp field, an Actual Payout field and a Sold Timestamp field. The LeadStore system 20 may further comprise one or more buyer account tables 66 that interfaces with the LeadStore lead server and stores information about each of the Lead Buyers in the LeadStore system and a lead leg sold table 68 that interfaces with the LeadStore lead server and stores information about the leads that are sold in the LeadStore system to each individual Lead Buyer.

In addition to the tables shown in FIG. 1, the LeadStore system 20 further may include a number of other tables including a lead ping table, a lead post table, a buyer campaign ping table, a budget table and a bid table. The lead ping table stores information about a ping (conditional bid for a particular type of lead that fits certain parameters). The lead post table stores information about a lead that has been posted for sale by a Lead Seller. The buyer campaign ping table stores information about one or more ping campaigns for one or more Lead Buyers. The budget table stores information about a budget for either a buyer campaign or a lead buyer account. The budget may specify the maximum number of leads and/or the maximum amount of money to spend on leads during one or more time periods and the budget may be associated with a particular buying campaign or with a particular Lead Buyer account.

The LeadStore system notifies Lead Buyers whenever new leads become available for purchase. The notification system may operate via e-mail, SMS text messaging, web-based connectivity, mobile phone applications, or any other means of notification. The Lead Buyer can use specific parameters (e.g., the location, type, characteristics, and quality, etc.) to describe the leads he/she/it would like to be notified of (availability for purchase) through the LeadStore system. The Lead Buyer can also specify whether he/she/it wants these notifications of new leads as soon as the leads are available, or at one or more specified time(s) as part of a daily/weekly/etc. batch delivery.

The LeadStore system shown in FIG. 1 facilitates the sale of Customer Leads to Lead Buyers. The system enables the Lead Buyer to view available leads from which to pick and choose for purchase. The Lead Buyer can also purchase leads on a subscription basis and/or build campaigns for automatic delivery of leads, for example by specifying parameters (e.g., the location, type, characteristics, and quality, etc.) of leads he/she/it would like to purchase, for example through a standing order called a “Buying Campaign.” Each buying campaign is set up by a Lead Buyer (where each Lead Buyer can have one or more buying campaigns) and allows the Lead Buyer of that buying campaign to specify certain parameters that are used to identify leads that are of interest to the particular Lead Buyer. For example, the buying campaign may 1) specify the price and budgets for buying Customer Leads in a “Fixed Buying Campaign”; and/or 2) provide instructions for the LeadStore system to make a server-to-server request for a price the Lead Buyer is willing to pay for each Customer Lead that enters the system in a “Ping Buying Campaign”. This Ping Buying Campaign is useful since many Lead Buyers will have systems through which they will resell the Customer Lead to another Buyer. Thus, the Ping Buying Campaign allows the Lead Buyer, through their servers, to receive a notification that a lead matches the ping buying campaign parameters, to check for demand for the Customer Lead in their system prior to committing to a price to pay to acquire the Customer Lead, and then to provide a bid for the Customer Lead in response to the notification. Of course, other purchasing schemes can also be used and the present invention is not limited to the examples of purchasing programs described above.

Since many Lead Sellers have systems used to manage the Customer Leads that they generate, the LeadStore system supports multiple methods for entering Customer Leads into the system for Sale. As shown in FIG. 1, Lead Sellers can set up their HTML Web forms to be submitted to the LeadStore directly by the customer. In addition, Lead Sellers that collect Customer Leads and save them on their own systems that can send the Customer Leads to the LeadStore system in a server-to-server exchange called a Server Post. The LeadStore system also makes it easier for Lead Sellers to Post Customer Leads to the system by converting the vertical-specific formats in which those leads exist into the universal format in which leads are stored in LeadStore table 58. By so doing, the LeadStore system eliminates the need for the Lead Seller to make significant modifications to their data structures in order to sell their Customer Leads. Since Lead Sellers may have established relationships with multiple partners that buy Customer Leads, the LeadStore allows Lead Sellers to make a server-to-server request for a quote prior to selling the Customer Lead through the LeadStore. This type of price quote request is called a “Ping”.

Once a Customer Lead is sold, the LeadStore creates “Lead Leg” records in the lead leg table for each of the Lead Buyers. These Lead Leg records are associated with the Customer Lead, which is associated with the Selling Campaign, which is associated with the Seller Account. The Lead Buyer accesses his or her own Lead Leg in the LeadStore, and the Buyer Rating, entered by the Lead Buyer through the LeadStore Buyer user interface, is stored in the Lead Leg record. Lead Buyer campaign creation and Lead Seller campaign creation are described in detail in U.S. Pat. No. 7,899,715, incorporated herein by reference.

In one embodiment, the Lead Buyer or Lead Seller can access the LeadStore system using a typical Web browser application by entering the appropriate user identification and password. The LeadStore system presents a Lead Buyer with a series of pages that enable the Lead Buyer to specify the characteristics of Customer Lead to purchase. The LeadStore system presents a Lead Seller with a series of pages that enable the Lead Seller to specify the Customer Leads and associate the data with a seller account. Such leads are converted to the universal format of the present invention, stored in the LeadStore and later selectively provided to Lead Buyers responsive to their lead criteria. Further details regarding the manner and methods by which leads may be provided are discussed in the above-cited U.S. Patent.

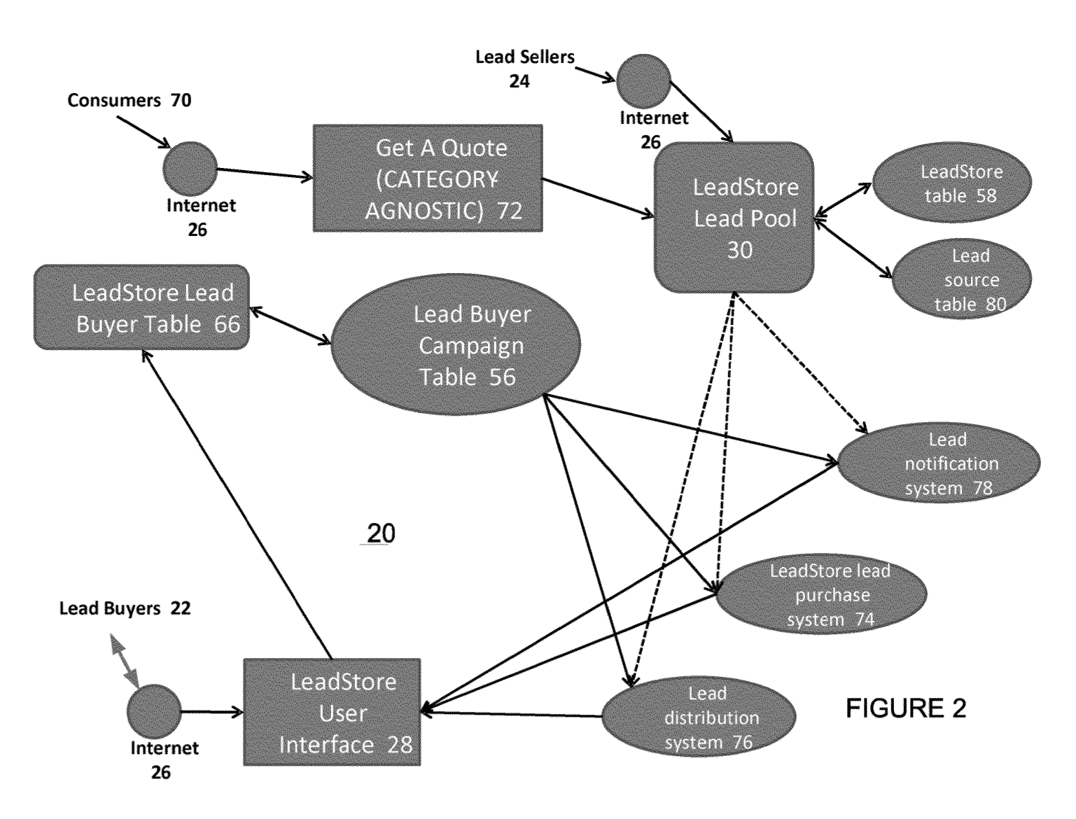

Turning now to FIG. 2, another view of the LeadStore system 20 is shown. In this illustration, not all of the components shown in FIG. 1 are illustrated. Further, some of the components illustrated in FIG. 1 are subsumed within other representations. As shown, the LeadStore system 20 brings together consumers 70, Lead Buyers 22 and Lead Sellers 24. Consumers can indicate their need for quotes (and thereby act as their own leads) directly, through a category-agnostic web interface 72 to the LeadStore server (a.k.a. LeadStore Lead Pool) 30. Lead Sellers 24 can likewise provide their leads for sale to the LeadStore server 30. All such leads are stored in the universal format in LeadStore table 58 and information regarding the source of the lead may be stored in lead source table 80.

Lead Buyers 22 can access the system through a web interface or dedicated application interface provided by LeadStore user interface server 28 and establish purchasing criteria (for on-demand, subscription-based or other purchasing regimes) as discussed above. Information regarding the Lead Buyers is stored in Lead Buyer table 66 and the purchasing campaign or other information is stored in Lead Buyer campaign table 56.

When available leads in the LeadStore table 58 are deemed to conform to purchasing criteria in the Lead Buyer campaign table 56, the LeadStore system 20 may transmit appropriate notifications to the associated lead buyer via the lead notification system 78. As indicated above, such notifications may be distributed in a variety of manners, potentially sequentially or in parallel so as to assure timely receipt by the Lead Buyer. Lead buyers can then purchase the leads using LeadStore Lead purchase System 74. In some instances (e.g., where subscriptions or existing purchase campaigns are in place), such purchases may be made automatically on behalf of the Lead Buyer by LeadStore system 20 and the associated leads may be automatically distributed to the Lead Buyer. Whether distributed automatically or on-demand, leads may be provided to the Lead Buyers using the lead distribution system 76, which in some instances may be operated by third parties different than those operating LeadStore system 20.

As should be apparent from the foregoing discussion, embodiments of the present invention may be implemented with the aid of computer-implemented processes or methods (a.k.a. programs or routines) that may be rendered in any computer language. Further, the present invention can be implemented with apparatus to perform the operations described herein. These apparatus may be specially constructed for the required purposes, or may comprise computer systems that are selectively activated or reconfigured by associated computer programs, which are executed and which are stored on one or more computer-readable storage mediums accessible to processing elements of the computer systems. For example, such a computer program may be stored in a computer readable storage medium, such as, but not limited to, any type of disk including floppy disks, optical disks, compact disk read only memories (CD-ROMs), and magnetic-optical disks, read-only memories (ROMs), flash drives, random access memories (RAMs), erasable programmable read only memories (EPROMs), electrically erasable programmable read only memories (EEPROMs), flash memories, other forms of magnetic or optical storage media, or any type of media suitable for storing electronic instructions, and each accessible to a computer processor, e.g., by way of a system bus or other communication means.

The algorithms and processes presented herein are not inherently related to any particular computer system, processor or other apparatus. Various electronic computing apparatus, along with, where necessary, suitable computer programs that instantiate processes in accordance with the teachings herein, may be used. For example, any of the present methods can be implemented in hard-wired circuitry, by appropriate programming of a computer processor or processors, or any combination of hardware and software may be used to carry out the methods discussed below. Of course, the invention can be practiced with computer system configurations other than those particularly described below, including systems that comprise hand-held devices, multiprocessor systems, microprocessor-based electronic devices, digital signal processor-based devices, networked computer systems, personal computers, and the like, and it should be recognized that these examples presented herein are used merely for purposes of illustration. The invention can also be practiced in distributed computing environments where tasks are performed by computer processing devices that are remote to one another, either physically and/or logically, and are linked through one or more communications networks. The required structure for a variety of these systems will appear from the description below.

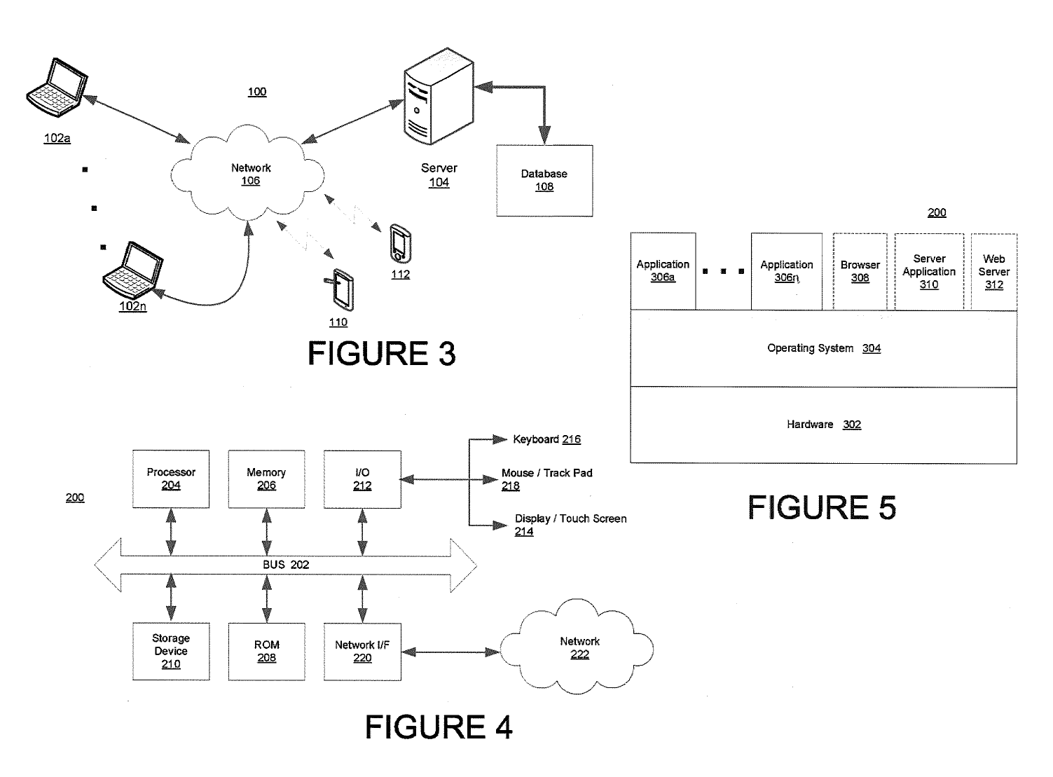

FIG. 3 includes a simplified illustration of a computer network 100 in which is an example of an environment in which the present invention may operate. Network 100 includes one or more client computer systems 102a-102n, which may be used to access a server 104 at which an instantiation of a computer-based application, which provides the category-agnostic LeadStore discussed above, may be installed and accessible. Such access may be by way of a computer network or network of networks 106, such as a local and/or wide area network. In some cases, network 106 may be or include the network of networks commonly known as the Internet. In other instances, network 106 may be a local area network (LAN) of an enterprise and/or a virtual LAN, which is instantiated over the Internet or other networks of networks. Server 104 is communicatively coupled to a database 108, which may store records concerning purchase authorizations, content, etc. Client computers 102a-102n may be any form of computer-based system, including personal computers, laptop computers, net book computers, mobile devices such as tablet computers 110, smart phones 112, and the like. Generally, a client computer 102 may run a Web browser application, through which the application running on server 104 may be accessed, however, as described herein client computers 102 may also run a client application specially configured to interface with the application running on server 104. References to a smart phone should be read as including tablet computers, portable computer (e.g., laptop computers, net books, etc.), and other forms of mobile, computer-based systems.

FIG. 4 shows a block diagram illustrating an example of a computer system 200. Any of client computer systems 102a-102n, 110, 112 and/or server 104 may be configured in the manner described for computer system 200. Computer system 200 includes a bus 202 or other communication mechanism for communicating information, and a processor 204 coupled with the bus 202 for processing information. Computer system 200 also includes a main memory 206, such as a random access memory (RAM) or other dynamic storage device, coupled to the bus 202 for storing information and instructions to be executed by processor 204. Main memory 206 also may be used for storing temporary variables or other intermediate information during execution of instructions to be executed by processor 204.

Computer system 200 further includes a read only memory (ROM) 208 or other static storage device coupled to the bus 202 for storing static information and instructions for the processor 204. A computer-readable storage device 210, such as a magnetic disk or optical disk, is provided and coupled to the bus 202 for storing information and instructions.

Computer system 200 may be coupled via the bus 202, either directly or via an input/output module 212, to a display 214, such as a flat panel display, for displaying information to a computer user. An input device 216, including alphanumeric and other keys, is coupled to the bus 202 for communicating information and command selections to the processor 204. Another type of user input device is cursor controller 218, such as a mouse, a trackball, or cursor direction keys for communicating direction information and command selections to processor 204 and for controlling cursor movement on the display 214. In some cases, for example with tablet-style computers, input may be by way of a touch screen display 214 rather than a keyboard/mouse combination.

As should be apparent, aspects of the present invention involve computer software running on clients 102, 110, 112, and server 104. That software may take the form of computer-executable instructions stored in main memory 206 and/or storage device 210, to be executed by processor 204. In other instances, the instructions may be stored on other computer-readable media, such as a floppy disk, a flexible disk, a hard disk, magnetic tape, or any other magnetic medium, a CD-ROM, or DVD-ROM, flash memory, or any other physical medium adapted to store computer-readable instruction and from which a computer processor can read. Execution of the sequences of instructions contained in the main memory 206 causes the processor 204 to perform the processes described herein. In alternative embodiments, hard-wired circuitry may be used in place of or in combination with computer software instructions to implement the invention. Thus, embodiments of the invention are not limited to any specific combination of hardware circuitry and software.

Computer system 200 also includes a network interface 220 coupled to the bus 202. Network interface 220 provides a two-way data communication path for computer system 200 to/from a network 222. For example, network interface 220 may be an integrated services digital network (ISDN) card or a modem to provide a data communication connection to a corresponding type of telephone line. As another example, communication interface 220 may be a LAN card to provide a data communication connection to a compatible LAN. Wireless communication links may also be implemented. In any such implementation, network interface 220 sends and receives electrical, electromagnetic or optical signals, which carry digital data streams representing various types of information. In one embodiment, network 222 may be network 106, or may be communicatively coupled thereto.

FIG. 5 shows an architecture view of computer system 200. The various hardware components of computer system 200 are represented as a hardware layer 302. An operating system 304 abstracts the hardware layer and acts as a host for various applications (such as the Exit Express applications discussed below) 306a-306m that run on computer system 200. In the case of a client computer system, the operating system may also act as a host for a Web browser application 308, while in the case of the server 104, the operating system acts as a host for a server application 310. For the server 104, the operating system may also host a web server application 312, which provides access from the client computers. In other instances, the web server may be hosted on a separate platform (not shown in detail), which may be communicatively coupled to a server hosting application 310.

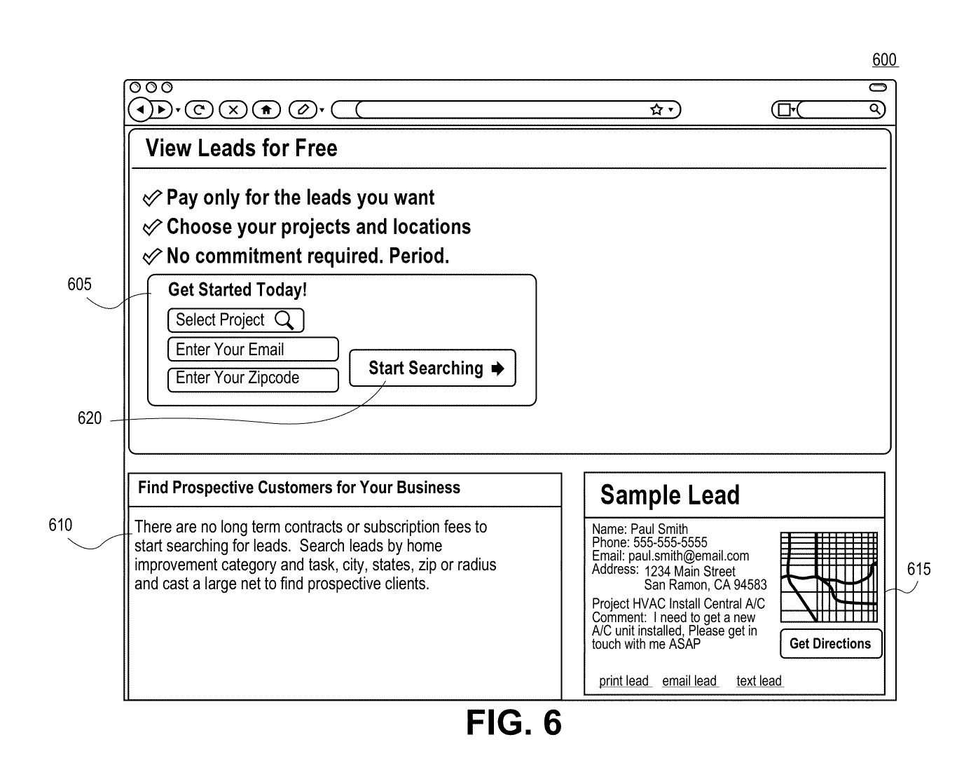

FIGS. 6-9 are screenshots depicting exemplary Web-based interfaces for implementing a lead-purchasing embodiment of the present invention. The screenshot of FIG. 6 depicts an exemplary introduction or home page interface 600 via which a user may interact with a lead purchasing system. Interface 600 includes a getting started window 605 which may include one or more user selectable options and text boxes which, upon selection, the user may begin a search for a lead to purchase. For example, getting started window 605 provides a “select project” lookup feature and text boxes via which a user may enter user identification or lead request information, such as an e-mail address and/or a zip code. Interface 600 may also include an informational window 610 that may include, for example, information regarding the lead purchasing system and/or the purchasing process. Interface 600 may further include a sample lead window 615 which may include, for example, information associated with a sample lead, such as a potential customer name, a project type, and/or a location.

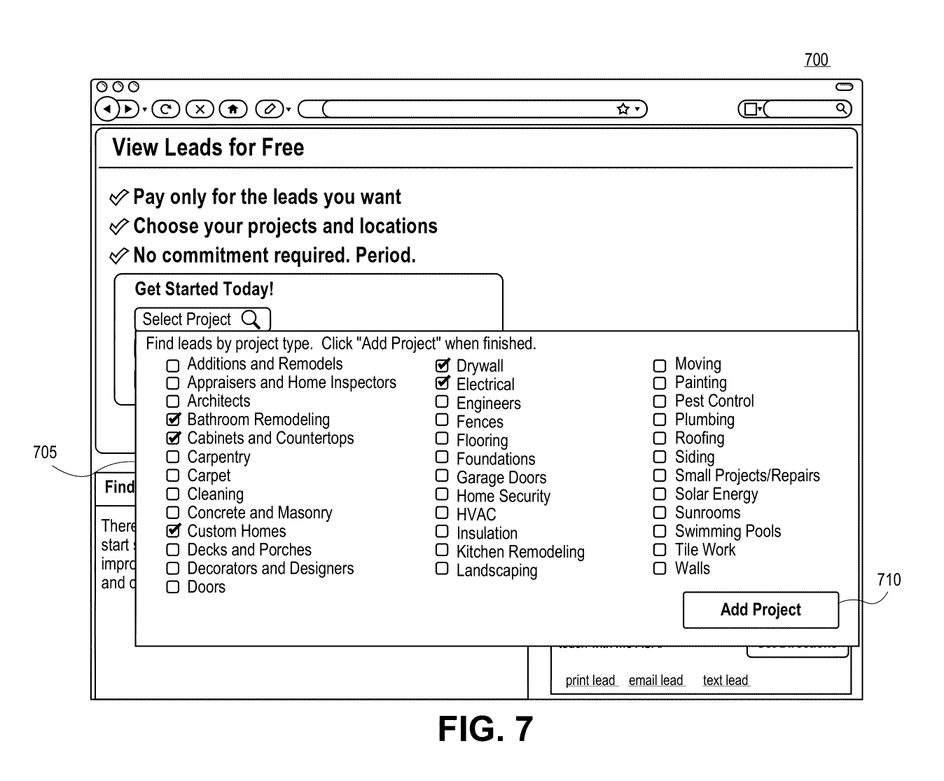

FIG. 7 is a screen shot of exemplary interface 700, which depicts an exemplary menu of projects 705 from which to select a lead. Menu of projects 705 may include a list of projects the user may select. In some embodiments, subcategories of projects may be nested within the project categories displayed in project menu 705 and a user may select o one or more of these projects subcategories. A user may complete the project selection process by, for example, selecting an “add project” button 710.

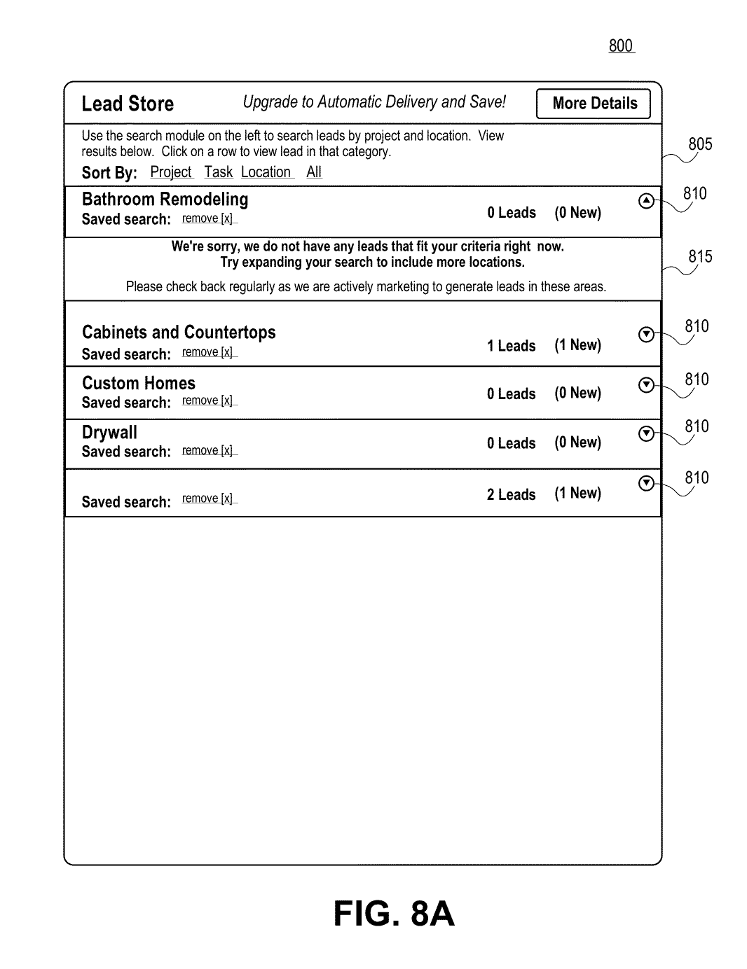

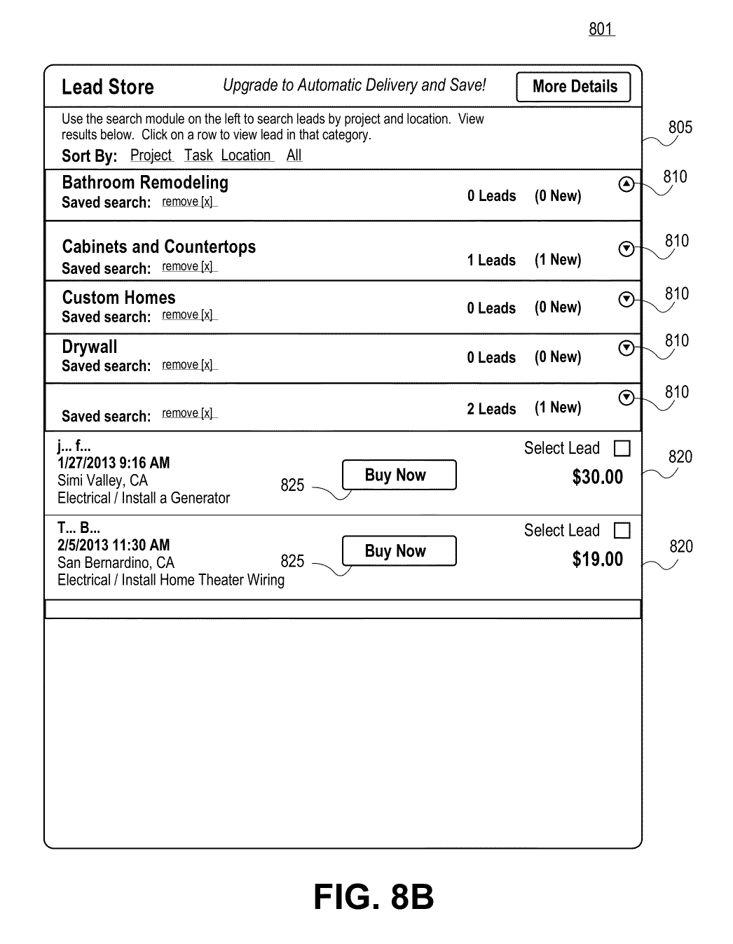

FIG. 8A is a screenshot of an exemplary Lead Store interface 800. Lead Store interface 800 may include a list 805 of one or more leads that match the user's selected project type and/or a location. For example, when a user selects project types bathroom remodeling, cabinets and countertops, custom homes, drywall, and electrical via interface 700 and selects “add project” button 710, the lead store system may search for one or more leads that match the selected project types and display a list of matching leads 805. Matching lead list 805 may include one or more leads that, on some occasions, may be organized, or grouped, according to project type. When just the project type, and not the lead, is displayed in matching lead list 805, one or more activation mechanisms 810 (e.g., selectable buttons) may be provided. Selection of an activation mechanism 810 may enable a user to view more information related to a lead displayed on matching lead list 805. For example, in FIG. 8A, an activation mechanism 810 associated with the bathroom remodeling project type has been selected in a message 815 indicating that there are no matching leads for this project type is displayed.

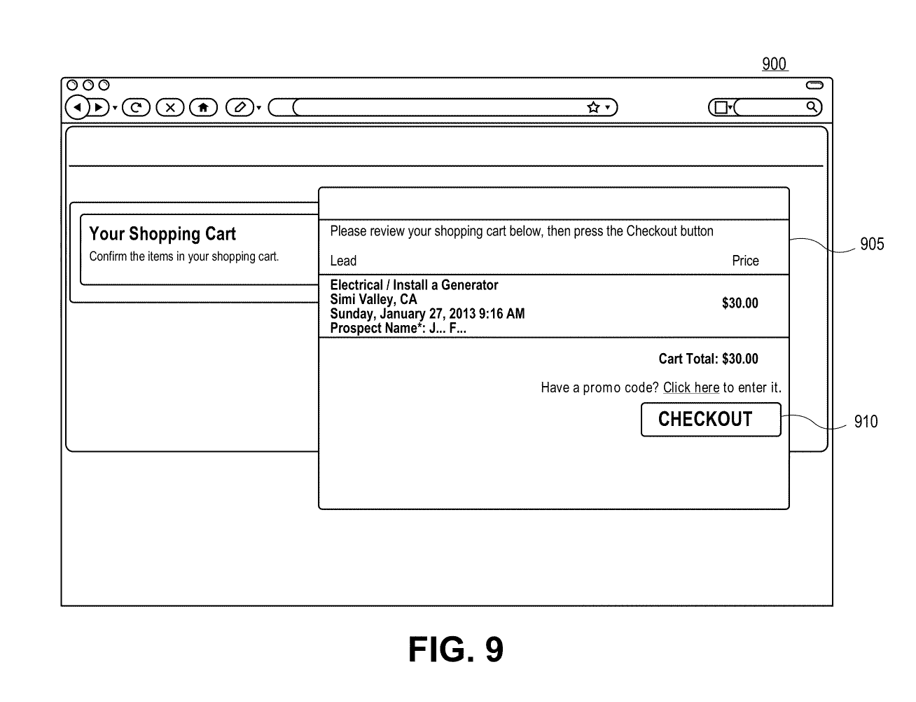

FIG. 8B is a screenshot of an exemplary lead store interface 801. Leads store interface 801 also displays a matching lead list 805 in which an activation mechanism 810 has been selected for the project type “electrical” and two matching leads 820 are displayed. Matching leaves 820 also include a purchasing mechanism 825, which, when selected, may enable a user to initiate a process for purchasing a corresponding lead such as a lead purchasing window 900 as depicted in FIG. 9. Lead purchasing window 900 may include a shopping cart 905 of leads selected from matching lead list 805 for purchase. In some embodiments, selection of purchasing mechanism 825 may cause display of shopping cart window 905. Upon selection of checkout button 910, a user may proceed with purchasing the lead by, for example, entering in payment information via another interface.

In some embodiments a series of interfaces similar to those depicted in FIGS. 6-9 may be provided to a lead seller for the purpose of submitting of a lead for sale by the LeadStore system.

Thus, a category-agnostic LeadStore that may find application in conjunction with various different types of leads has been described. While the foregoing has been with reference to a particular embodiment of the invention, it will be appreciated by those skilled in the art that changes in this embodiment may be made without departing from the principles and spirit of the invention.

What is claimed is:

1. A computer-implemented method comprising:
receiving a plurality of customer leads at a lead store system, the leads being in a variety of formats, wherein each lead includes a set of information about a prospective customer who may purchase a good or service;
converting the leads to a universal format by the lead store system, the universal format being category and industry agnostic;
storing, by the lead store system, the converted leads in a database;
receiving a request for a lead from a lead buyer at the lead store system, the request including at least one criterion;
matching the criterion to a stored converted lead by the lead store system; and
providing, by the lead store system, the matching lead to the lead buyer.

2. The computer-implemented method of claim 1, further comprising:
requesting, by the lead store system, payment for the matching lead from the lead buyer prior to providing the matching lead to the lead buyer;
receiving payment for the matching lead from the lead buyer at the lead store system; and
providing, by the lead store system, the matching lead to the lead buyer responsively to the received payment.

3. The computer-implemented method of claim 1, wherein a portion of the leads are received from a lead seller and are grouped into a lead seller campaign, the method further comprising:
tracking characteristics of the leads included in the lead seller campaign over time.

4. The computer-implemented method of claim 3, wherein a portion of the leads are received from a lead seller and are grouped into a lead seller campaign, the method further comprising:
tracking the purchase history of leads included in the lead seller campaign over time.

5. The computer-implemented method of claim 3, wherein the lead seller campaign includes leads generated according to a plurality of methods.

6. The computer-implemented method of claim 1, wherein the lead buyer has a lead buyer campaign that includes a set of parameters for desired leads.

7. The computer-implemented method of claim 1, wherein the lead buyer has a lead buyer campaign that includes a set of parameters for desired leads, the method further comprising:
receiving the lead buyer campaign at the lead store system; and
providing, by the lead store system, leads to the lead buyer responsively to the received lead buyer campaign.

8. The computer-implemented method of claim 7, further comprising:
receiving a new lead at the lead store system;
determining, by the lead store system, whether the newly received lead matches the lead buyer campaign; and
notifying, by the lead store system, the lead buyer of the newly received bid responsively to the determination.

9. The computer-implemented method of claim 1, further comprising:
receiving a new lead at the lead store system; and
notifying, by the lead store system, the lead buyer of the newly received lead.

10. A lead store system comprising:
a link for receiving a plurality of customer leads, the leads being in a variety of formats, wherein each lead includes a set of information about a prospective customer who may purchase a good or service, receiving a request for a lead from a lead buyer, the request including at least one criterion, and providing the matching lead to the lead buyer;
a processor communicatively coupled to the link, the processor being configured to receive the leads and requests for a lead from the link, convert the leads to a universal format, the universal format being category and industry agnostic, accessing a storage unit configured to store the converted leads upon receiving the request for the lead, matching the criterion of the received request to a stored converted lead, and providing the matching lead to the link; and
the storage unit configured to store the converted leads.

11. The lead store system of claim 10, further comprising:
a seller lead database configured to store leads to be sold and a lead seller campaign table that includes a portion of the received leads associated with a particular lead seller grouped into a lead seller campaign.

12. The lead store system of claim 10, further comprising:
a lead buyer database configured to store criteria for leads the lead buyer is interested in purchasing.

13. A computer-readable media storing thereon a set of instructions thereon, which when executed by a lead store system cause the lead store system to:
receive a plurality of customer leads, the leads being in a variety of formats, wherein each lead includes a set of information about a prospective customer who may purchase a good or service;
convert the leads to a universal format, the universal format being category and industry agnostic;
store the converted leads in a database;
receive a request for a lead from a lead buyer, the request including at least one criterion;
match the criterion to a stored converted lead; and
provide the matching lead to the lead buyer.
